(19) United States
(12) Patent Application Publication
(10) Pub. No.: US 2024/0073839 A1
(43) Pub. Date: Feb. 29, 2024

(54) RADIO COMMUNICATION NODE

(71) Applicant: NTT DOCOMO, INC., Tokyo (JP)

(72) Inventors: Daisuke Kurita, Tokyo (JP); Hiroki Harada, Tokyo (JP); Weiqi Sun, Beijing (CN); Jing Wang, Beijing (CN); Xiaolin Hou, Beijing (CN)

(73) Assignee: NTT DOCOMO, INC., Tokyo (JP)

(21) Appl. No.: 17/754,701

(22) PCT Filed: Oct. 9, 2019
(86) PCT No.: PCT/JP2019/039917

§ 371 Date: Apr. 8, 2022

(51) Int. Cl. H04W 56/00

(52) U.S. Cl. CPC H04W 56/0045

(57) ABSTRACT

A radio communication node 100A acquires, in a case in which a DL transmission timing and a UL transmission timing in a radio communication node 100B, a propagation delay between the radio communication node 100A and the radio communication node 100B and transmits timing information including the propagation delay to the radio communication node 100B.

### TECHNICAL FIELD

The present invention relates to a radio communication node that sets up radio access and radio backhaul.

### BACKGROUND ART

In the 3rd Generation Partnership Project (3GPP), Long Term Evolution (LTE) has been specified, and LTE-Advanced (hereinafter referred to as LTE including LTE-Advanced) and 5G New Radio (NR) or successor systems of LTE called Next Generation (NG) or the like have been specified.

For example, in a radio access network (RAN) of NR, integrated access and backhaul (IAB) in which radio access to a user equipment (UE) and radio backhaul between radio communication nodes such as radio base stations (gNBs) are integrated is under reviewed (see Non Patent Literature 1).

In IAB, an IAB node includes s mobile termination (MT) which is a function of establishing a connection with a parent node (which may be called an IAB donor) and a distributed unit (DU) which is a function of establishing a connection with a child node or a UE.

In Release 16 of 3GPP, the radio access and the radio backhaul are on the basis of half-duplex communication and time division multiplexing (TDM). In Release 17 and later, application of space division multiplexing (SDM) and frequency division multiplexing (FDM) is under review.

In Non Patent Literature 1, seven cases are specified regarding the adjustment (alignment) of a transmission timing between the parent node and the IAB node. For example, as a premise, a downlink (DL) transmission timing adjustment (Case #1) between the IAB node and IAB donor, a DL and uplink (UL) transmission timing adjustment within the IAB node (Case #2), and a combination of transmission timing adjustments between DL of Case #1 and UL Case #2 (Case #6) are specified.

In the case of Case #1, it was agreed that, in order to cause the DL transmission timings in the DUs of the respective nodes to align with each other, the IAB node calculates a propagation delay (T_{propagation_0}) of a path (0) with the parent node using a formula (TA/2+T_delta) and offsets the transmission timing and transmits the resulting transmission timing.

Here, TA is a value of Timing Advance to determine the transmission timing of the UE specified in 3GPP Release 15, and T_delta is determined in consideration of a switching time from reception to transmission of the parent node.

### CITATION LIST

### Non Patent Literature

Non Patent Literature 1: 3GPP TR 38.874 V16.0.0, 3rd Generation Partnership Project; Technical Specification Group Radio Access Network; NR; Study on Integrated Access and Backhaul; (Release 16), 3GPP, December, 2018

### SUMMARY OF INVENTION

As described above, in Case #6, in addition to Case #1, specifically, the DL transmission timing adjustment of the IAB node and IAB donor DU, it is necessary to implement the adjustment of Case #2, specifically, the DL and UL transmission timing adjustments in the IAB node.

In other words, in a case in which Case #6 is supported, in addition to Case #1, it is necessary to cause the UL transmission timing of the MT to coincide with the DL transmission timing of the IAB node and the child node DU as well.

In this regard, the present invention was made in light of the foregoing, and it is an object of the present invention to provide a radio communication node which is capable of reliably causing the transmission timings of the distributed unit (DU) and the mobile termination (MT) to coincide with each other in the Integrated Access and Backhaul (IAB).

According to an aspect of the present disclosure, a radio communication node (a radio communication node 100A) includes a control unit (a control unit 140) that acquires, in a case in which a downlink transmission timing and an uplink transmission timing in a lower node (for example, a radio communication node 100B) are adjusted, a propagation delay between the radio communication node and the lower node and a transmitting unit (a timing information transmitting unit 150) that transmits timing information including the propagation delay to the lower node.

According to an aspect of the present disclosure, a radio communication node (a radio communication node 100B) includes a control unit (a control unit 170) that causes, in a case in which a downlink transmission timing and an uplink transmission timing in the radio communication node are adjusted, the uplink transmission timing to align with the downlink transmission timing and a transmitting unit (a radio transmitting unit 161) that transmits an uplink on the basis of the transmission timing.

According to an aspect of the present disclosure, a radio communication node (a radio communication node 100A) includes a control unit (a control unit 140) that acquires, in a case in which a downlink transmission timing and an uplink transmission timing in a lower node (a radio communication node 100B) are adjusted, a first propagation delay between the radio communication node and the lower node used for determining the downlink transmission timing and a second propagation delay between the radio communication node and the lower node used for determining the uplink transmission timing and a transmitting unit (a timing information transmitting unit 150) that transmits timing information including the first propagation delay and the second propagation delay to the lower node.

According to an aspect of the present disclosure, a communication node (a radio communication node 100A) includes a control unit (a control unit 140) that acquires, in a case in which a downlink transmission timing and an uplink transmission timing in a lower node (a radio communication node 100B) are adjusted, a first propagation delay between the radio communication node and the lower node used for determining the downlink transmission timing and a second propagation delay between the radio communication node and the lower node used for determining the uplink transmission timing and a transmitting unit (a timing information transmitting unit 150) that transmits timing information including a difference between the first propagation delay and the second propagation delay to the lower node.

According to an aspect of the present disclosure, a radio communication node (a radio communication node 100A) includes a control unit (a control unit 140) that determines whether or not to adjust a downlink transmission timing and an uplink transmission timing in a lower node, and a transmitting unit (a timing information transmitting unit 150) that transmits, in a case in which the downlink transmission timing and the uplink transmission timing in the lower node are determined to be adjusted, information indicating that the downlink transmission timing and the uplink transmission timing in the lower node are adjusted to the lower node.

According to an aspect of the present disclosure, a radio communication node (a radio communication node 100B) includes a radio unit that transmits and receives radio signals using a single panel and a transmitting unit (a capability transmitting unit 180) that transmits information indicating that the panel is used to a higher node (a radio communication node 100A).

### BRIEF DESCRIPTION OF DRAWINGS

FIG. 1 is an overall configuration diagram of a radio communication system 10.

FIG. 2 illustrates a basic configuration example of IAB.

FIG. 3 is a functional block configuration diagram of a radio communication node 100A that constitutes a parent node.

FIG. 4 is a functional block configuration diagram of a radio communication node 100B that constitutes an IAB node.

FIG. 5 is a diagram illustrating an example of a relation between T_{propagation_0}, TA, and T_delta.

FIG. 6 is a diagram illustrating an example of transmission timings of a parent node and an IAB node (Case #1) in a case in which a condition 1 is applied.

FIG. 7 is a diagram illustrating an example of transmission timings of a parent node and an IAB node (Case #6) in a case in which a condition 1 is applied.

FIG. 8 is a diagram illustrating an example of transmission timings of a parent node and an IAB node in a case in which a condition 2 is applied.

FIG. 9 is a diagram illustrating an example of transmission timings of a parent node and an IAB node according to an operation example 1a.

FIG. 10 is a diagram illustrating a configuration example of a random access response (PAR) and a MAC-CE.

FIG. 11 is a diagram illustrating an example of transmission timings of a parent node and an IAB node according to an operation example 3-1.

FIG. 12 is a diagram illustrating an example of transmission timings of a parent node and an IAB node according to an operation example 4-2.

FIG. 13 is a diagram illustrating an example of a hardware configuration of each of a CU 50 and radio communication nodes 100A to 100C.

### DESCRIPTION OF EMBODIMENTS

Hereinafter, an exemplary embodiment will be described with reference to the appended drawings. Note that the same functions or configurations are denoted by the same or similar reference numerals, and description thereof will be omitted as appropriate.

### (1) Overall Schematic Configuration of Radio Communication System

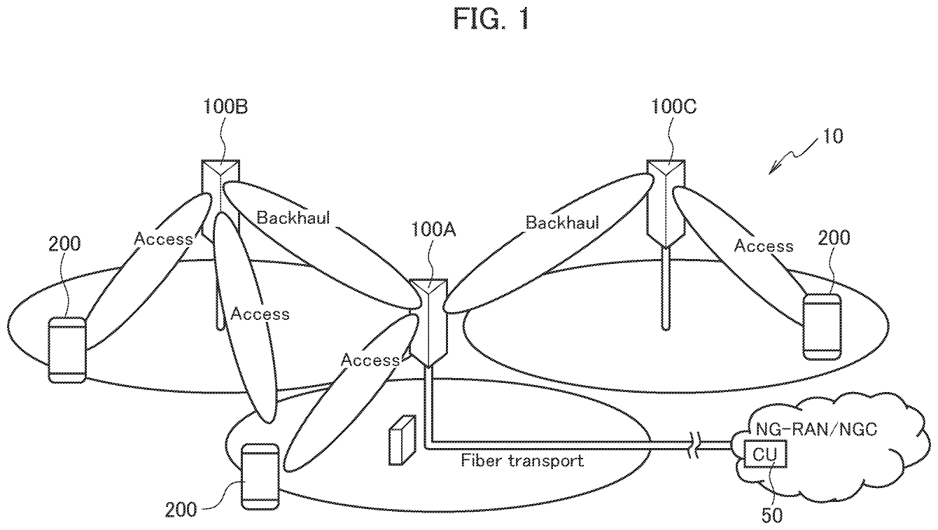

FIG. 1 is an overall configuration diagram of a radio communication system 10 according to the present embodiment. The radio communication system 10 is a radio communication system that complies with 5G New Radio (NR) and includes a plurality of radio communication nodes and a user equipment.

Specifically, the radio communication system 10 includes radio communication nodes 100A, 100B, and 100C and a user equipment 200 (hereinafter, the UE 200).

The radio communication nodes 100A, 100B, and 100C can set radio access with the UE 200 and radio backhaul (BH) between the radio communication nodes. Specifically, a backhaul (transmission path) by a radio link is set between the radio communication node 100A and the radio communication node 100B and between the radio communication node 100A and the radio communication node 100C.

As described above, the configuration in which the radio access with the UE 200 and the radio backhaul between the radio communication nodes are integrated is called integrated access and backhaul (IAB).

In IAB, the existing functions and interfaces defined for radio access are reused. In particular, interfaces corresponding to a mobile-termination (MT), a gNB-DU (distributed Unit), a gNB-CU (central unit), a user plane function (UPF), an access and mobility management function (AMF), and a session management function (SMF) such as NR Uu (between the MT and the gNB/DU), F1, NG, X2, and N4 are used as a base line.

The radio communication node 100A is connected to a radio access network (NG-RAN) and a core network (next generation core (NGC) or 5GC) of NR via a wired transmission path such as a fiber transport. The NG-RAN/NGC includes a central unit 50 (hereafter, a CU 50) which is a communication node. Further, NG-RAN and NGC may be also referred to simply as a “network.”

The CU 50 may be configured with any of the UPF, the AMF, the SMF, and a combination thereof. Alternatively, the CU 50 may be a gNB-CU as described above.

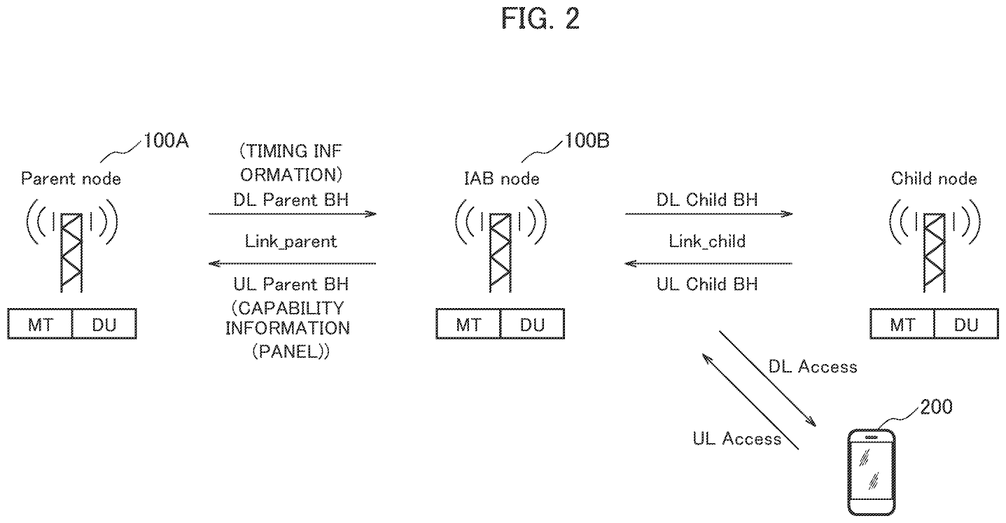

FIG. 2 illustrates a basic configuration example of IAB. As illustrated in FIG. 2, in the present embodiment, the radio communication node 100A constitutes a parent node (Parent node) in IAB, and the radio communication node 100B (and the radio communication node 100C) constitutes an IAB node in IAB. The parent node may be called an IAB donor.

The child node in IAB is configured with other radio communication nodes not illustrated in FIG. 1. Alternatively, the UE 200 may constitute the child node.

A radio link is configured between the parent node and the IAB node. Specifically, a radio link called Link_parent is configured.

The radio link is configured between the IAB node and the child node. Specifically, a radio link called Link child is configured.

Such a radio link set between radio communication nodes is called a radio backhaul link. Link_parent is configured with DL Parent BH in the downlink (DL) direction and UL Parent BH in the uplink (UL) direction. Link child is configured with DL Child BH in the DL direction and UL Child BH in the UL direction.

In other words, in IAB, the direction from the parent node to the child node (including the UE 200) is the DL direction, and the direction from the child node to the parent node is the UL direction.

The radio link configured between the UE 200 and the IAB node or the parent node is called a radio access link. Specifically, the radio link is configured with DL Access in the DL direction and UL Access in the UL direction.

The IAB node includes a mobile termination (MT) which is a function for establishing a connection with the parent node and a distributed unit (DU), which is a function for establishing a connection with the child node (or the UE 200). The child node may be called the lower node.

Similarly, the parent node includes the MT for establishing a connection with the higher node and the DU for establishing a connection with the lower node such as the IAB node. The parent node may include a CU (central unit) instead of the MT.

Similarly to the IAB node and the parent node, the child node also includes the MT for establishing a connection with a higher node such as the IAB node and the DU for establishing a connection with a lower node such as the UE 200.

As the radio resources used by the DU, DL, UL, and Flexible time-resource (D/U/F) are classified into any one type of hard, soft, and Not Available (H/S/NA) from the point of view of the DU. Also, available (available) or unavailable (not available) is specified even within soft (S).

Note that the configuration example of IAB illustrated in FIG. 2 uses CU/DU division, but the IAB configuration is not necessarily limited to such a configuration. For example, IAB may be configured by tunneling using GPRS Tunneling Protocol (GTP)-U/User Datagram Protocol (UDP)/Internet Protocol (IP) for the radio backhaul.

The main advantage of IAB is that cells of NR can be flexibly and densely arranged without densifying the transport network. IAB can be applied to various scenarios such as outdoor or indoor small cell arrangement and mobile relay (for example, in buses or trains).

Also, as illustrated in FIG. 1 and FIG. 2, IAB may support deployment by only stand-alone (SA) of NR or deployment by non-stand-alone (NSA) including other RAT (LTE or the like).

In the present embodiment, the radio access and the radio backhaul operate on the premise of half-duplex communication. However, the present embodiment is not necessarily limited to half-duplex communication, and full-duplex communication may be used as long as the requirements are satisfied.

Further, time division multiplexing (TDM), space division multiplexing (SDM), and frequency division multiplexing (FDM) can be used as a multiplexing scheme.

In a case in which the IAB node operates according to half-duplex, the DL Parent BH serves as a receiving (RX) side, the UL Parent BH serves as a transmitting (TX) side, the DL Child BH serves as a transmitting (TX) side, the UL Child BH serves as a receiving (RX) side. Further, in the case of time division duplex (TDD), a configuration pattern of DL/UL in the IAB node is not limited to DL-F-UL only, and configuration patterns such as radio backhaul (BH) and UL-F-DL may be applied.

In the present embodiment, simultaneous operation of the DU and the MT of the IAB node is implemented using SDM/FDM.

### (2) Functional Block Configuration of Radio Communication System

Next, functional block configurations of the radio communication node 100A and the radio communication node 100B that constitute the radio communication system 10 will be described.

### (2.1) Radio Communication Node 100A

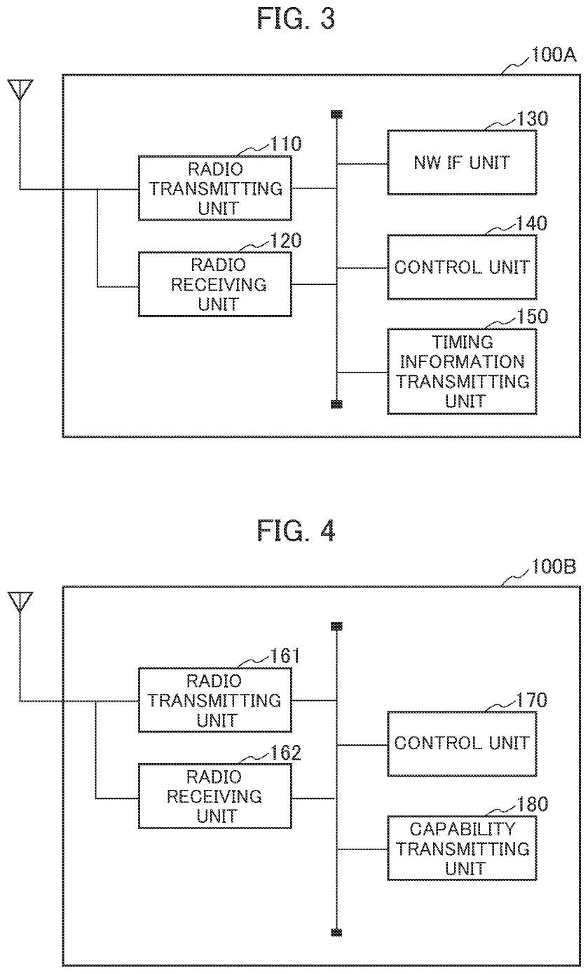

FIG. 3 is a functional block configuration diagram of a radio communication node 100A that constitutes a parent node. As illustrated in FIG. 3, the radio communication node 100A includes a radio transmitting unit 110, a radio receiving unit 120, a NW IF unit 130, a control unit 140, and a timing information transmitting unit 150.

The radio transmitting unit 110 transmits radio signals according to the 5G specifications. Also, the radio receiving unit 120 transmits radio signals according to the 5G specifications. In the present embodiment, the radio transmitting unit 110 and the radio receiving unit 120 execute radio communication with the radio communication node 100B that constitutes the IAB node.

In the present embodiment, the radio communication node 100A has functions of the MT and the DU, and the radio transmitting unit 110 and radio receiving unit 120 also transmit and receive radio signals corresponding to MT/DU.

The NW IF unit 130 provides a communication interface for implementing a connection with the NGC side or the like. For example, the NW IF unit 130 may include an interface such as X2, Xn, N2, or N3.

The control unit 140 controls the respective functional blocks that constitute the radio communication node 100A. Particularly, in the present embodiment, the control unit 140 controls the transmission timings of DL and UL. Specifically, the control unit 140 can adjust the DL transmission timing and the UL transmission timing in the lower node, for example, in the radio communication node 100B (the IAB node).

In the control unit 140, the DL transmission timing adjustment of each radio communication node including the radio communication node 100A may correspond to Case #1 specified in 3GPP TR 38.874 as will be described later.

Also, the UL transmission timing adjustment in the IAB node may correspond to Case #2. The adjustment in the IAB node may include the DL transmission timing adjustment in the IAB node, or the DL and UL transmission timings may be adjusted in the IAB node.

In other words, the control unit 140 can support Case #6 which is a combination of the DL transmission timing adjustment of Case #1 and the UL transmission timing adjustment of Case #2.

In a case in which the DL transmission timing and the UL transmission timing in the IAB node are adjusted (which may be interchangeably interpreted as a case corresponding to Case #6), the control unit 140 acquires the propagation delay between the radio communication node 100A (the parent node) and the radio communication node 100B (the lower node).

Specifically, the control unit 140 calculates the propagation delay of the path (0) between the parent node and the lower node on the basis of Formula (1).

T_{propagation_0}=(TA/2+T_delta) (Formula 1)

TA is a value of Timing Advance (TA) for determining the transmission timing of the UE specified in 3GPP Release 15. Also, T_delta is determined in consideration of a switching time from reception to transmission of the parent node or the like. The calculation method of T_{propagation_0} will be described later.

As described above, when the DL transmission timing and the UL transmission timing in the IAB node are adjusted, the control unit 140 may acquire a propagation delay (a first propagation delay) between the radio communication node 100A (the parent node) and the radio communication node 100B (the lower node) used for determining the DL transmission timing and a propagation delay (a second propagation delay) between the radio communication node 100A and the radio communication node 100B used for determining the UL transmission timing in the radio communication node 100B.

The propagation delay may mean T_{propagation_0} or may mean TA/2 or TA. Further, the propagation delay may be called a transmission time, a delay time, simply a delay, or the like, and may be called other names as long as it indicates a time necessary for DL or UL transmission between the radio communication nodes constituting IAB.

Further, the control unit 140 may determine whether or not to adjust the DL transmission timing and the UL transmission timing in the IAB node (the lower node). Specifically, the control unit 140 may determine whether or not Case #6 which is a combination of the DL transmission timing adjustment of Case #1 and the UL transmission timing adjustment of Case #2 is supported.

The timing information transmitting unit 150 transmits information related to the DL or UL transmission timing to the lower node. Specifically, the timing information transmitting unit 150 can transmit the information related to the DL or UL transmission timing to the IAB node and/or the child node.

More specifically, the timing information transmitting unit 150 transmits timing information including the propagation delay (T_{propagation_0}) between the radio communication node 100A (the parent node) and the radio communication node 100B (the lower node) to the lower node. In the present embodiment, the timing information transmitting unit 150 constitutes a transmitting unit that transmits the timing information to the lower node.

The timing information transmitting unit 150 may transmit, to the lower node, timing information including the propagation delay (the first propagation delay) between the radio communication node 100A (the parent node) and the radio communication node 100B (the lower node) used for determining the DL transmission timing and the propagation delay (the second propagation delay) between the radio communication node 100A and the radio communication node 100B used for determining the UL transmission timing in the radio communication node 100B.

Alternatively, the timing information transmitting unit 150 may transmit timing information including a difference (T_offset) between the first propagation delay and the second propagation delay to the lower node.

In a case in which it is determined to adjust the DL transmission timing and the UL transmission timing in the IAB node, the timing information transmitting unit 150 may transmit information indicating that the DL transmission timing and the UL transmission timing in the IAB node are to be adjusted to the lower node, that is, the IAB node.

The timing information may be configured with only of T_{propagation_0} and/or T_offset.

Also, the timing information can be transmitted using a TA command in a Random Access Response (PAR) or a Medium Access Control-Control Element (MAC-CE). Similarly, the information indicating that the DL transmission timing and the UL transmission timing in the IAB node are to be adjusted may also be transmitted using the MAC-CE or may be transmitted using an appropriate channel or signaling of an upper layer (a radio resource control (RRC) layer or the like).

Further, the timing information may also be transmitted using appropriate channel or signaling of the upper layer.

Control channels and a data channels are included in channels. The control channels include a physical downlink control channel (PDCCH), a physical uplink control channel (PUCCH), a physical random access channel (PRACH), and a physical broadcast channel (PBCH).

The data channels include a physical downlink shared channel (PDSCH) and a physical uplink shared channel (PUSCH).

Further, reference signals include a demodulation reference signal (DMRS), a sounding reference signal (SRS), a phase tracking reference signal (PTRS), and a channel state information-reference signal (CSI-RS), and the channels and the reference signals are included as signals. Also, data may mean data transmitted via the data channel.

The UCI is control information which is symmetric downlink control information (DCI) and is transmitted via a PUCCH or a PUSCH. The UCI may include a scheduling request (SR), a hybrid automatic repeat request (HARQ) ACK/NACK, and a channel quality indicator (CQI).

### (2.2) Radio Communication Node 100B

FIG. 4 is a functional block configuration diagram of a radio communication node 100B that constitutes an IAB node. As illustrated in FIG. 4, the radio communication node 100B includes a radio transmitting unit 161, a radio receiving unit 162, a control unit 170, and a capability transmitting unit 180.

The radio transmitting unit 161 transmits radio signals according to the 5G specifications. Also, the radio receiving unit 162 transmits radio signals according to the 5G specifications. In the present embodiment, the radio transmitting unit 161 and the radio receiving unit 162 executes radio communication with the radio communication node 100A that constitutes the parent node and executes radio communication with the child node (including the UE 200).

In the present embodiment, the radio transmitting unit 161 and the radio receiving unit 162 constitute a radio unit that transmits/receives radio signals using a single panel. The panel may be called an antenna panel or may be interpreted interchangeably with a beam or the like.

In other words, the radio transmitting unit 161 and the radio receiving unit 162 can perform transmission and reception of radio signals with the higher node and the lower node using a single panel with no multi-beam support. The radio transmitting unit 161 and the radio receiving unit 162 include a plurality of panels but may transmit and receive radio signals using only a single panel.

Further, in the present embodiment, the radio transmitting unit 161 constitutes a transmitting unit that performs UL transmission on the basis of the UL transmission timing. Specifically, the radio transmitting unit 161 transmits the UL using the MT function in accordance with the UL transmission timing adjusted by the control unit 170.

The control unit 170 controls the respective functional blocks that constitute the radio communication node 100B. In particular, in the present embodiment, the control unit 170 adjusts the DL transmission timing and the UL transmission timing in the radio communication node 100B (lower node).

Specifically, the control unit 170 causes the UL transmission timing to align with the DL transmission timing when the DL transmission timing and the UL transmission timing in the radio communication node 100B (the lower node) are adjusted. In other words, the control unit 170 causes the UL transmission timing to align with the DL transmission timing with reference to the DL transmission timing.

The capability transmitting unit 180 transmits information related to the capability of the radio communication node 100B to the higher node such as the radio communication node 100A. The capability transmitting unit 180 may transmits the information to the CU 50 (see FIG. 1).

Further, the capability transmitting unit 180 can transmit information indicating that the radio transmitting unit 161 and the radio receiving unit 162 use a single panel to the higher node. In the present embodiment, the capability transmitting unit 180 constitutes a transmitting unit that transmits the information indicating that a single panel is used (which may be called capability information) to the higher node.

Specifically, the capability transmitting unit 180 can transmit the information to the higher node by using a physical layer or signaling of the upper layer.

### (3) Operation of Radio Communication System

Next, an operation of the radio communication system 10 will be described. Specifically, the operation related to the DL and UL transmission timing adjustments in the radio communication system 10 will be described.

More specifically, the DL and UL transmission timing adjustments in IAB in which SDM and/or FDM are used as the multiplexing scheme, particularly, the DL and UL transmission timing adjustments operations in a case in which Case #6 specified in 3GPP TR 38.874 is applied will be described.

### (3.1) Content of Provisions of 3GPP

First, content of the provisions of 3GPP will be described. In 3GPP TR 38.874 (for example, V16.0.0), the following seven cases are specified to cause the DL or UL transmission timing to be aligned between the radio communication nodes that constitute IAB.
(Case #1): DL transmission timing adjustment between the IAB node and IAB donor
(Case #2): DL and UL transmission timing adjustments in the IAB node
(Case #3): DL and UL reception timing adjustments in the IAB node
(Case #4): Transmission by Case #2 and Reception by Case #3 in the IAB node
(Case #5): Application of Case #1 to an access link timing in the IAB node in a different time slot and application of Case #4 to a backhaul link timing.
(Case #6): DL transmission timing adjustment of Case #1+UL transmission timing adjustment of Case #2
(Case #7): DL transmission timing adjustment of Case #1+UL reception timing adjustment of Case #3

In 3GPP Release 16, as described above, it was agreed that, in order to cause the DL transmission timing of the DU to be aligned between the radio communication nodes that constitute the IAB, the IAB node calculates the propagation delay (T_{propagation_0}) of the path (0) with the parent node using Formula (TA/2+T_delta) and offsets the transmission timing and transmits the resulting transmission timing.

Here, TA is a value of Timing Advance to determine the transmission timing of the UE specified in 3GPP Release 15, and T_delta is determined in consideration of a switching time from reception to transmission of the parent node.

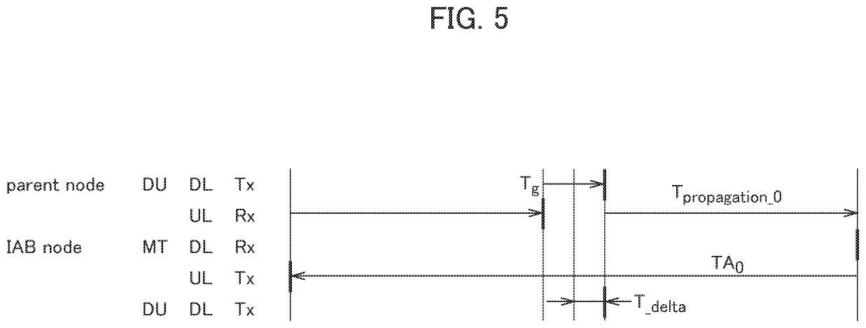

FIG. 5 is a diagram illustrating an example of a relation between T_{propagation_0}, TA, and T_delta. As illustrated in FIG. 5, T_{propagation_0} is the value obtained by adding T_delta to the value obtained by dividing TA₀ between the parent node and the IAB node by two. T_delta corresponds to the value obtained by dividing a gap (Tg) accompanying the switching time from UL reception to DL transmission in the parent node by two.

An operation related to the DL and UL transmission timings in a case in which the radio communication node that constitutes IAB supports Case #6 in addition to Case #1 will be described below. In a case in which Case #6 is supported, the UL transmission timing of the MT is aligned with the DL transmission timing of the IAB node and the child node DU in addition to Case #1.

The following contents may be assumed as the premise of the operation example to be described later.
Due to the restrictions of half-duplex communication, any one of TDM/SDM/FDM is applied to the backhaul link and the access link of the IAB node. In the case of SDM or FDM, the DU and the MT can perform transmission and reception at the same time.
In a case in which SDM/FDM using a single panel is supported, it is necessary to support Case #6 for simultaneous transmission in the IAB node or to support Case #7 for simultaneous reception in the IAB node.
Case #1 is supported by both of the transmission timings of the backhaul link and the access link.
Case #7 is supported only when it is compatible with the UE of Release 15.
it is necessary for the IAB to set the DL transmission timing to TA/2+T_delta prior to the DL reception timing.
A notification of T_delta is given from the parent node. Factors such as an offset between DL transmission and UL reception of the parent node caused by factors such as the switching time from transmission to reception (or vice versa) or hardware failure are considered in the value of T_delta.
TA is derived on the basis of the provisions of Release 15. TA is interpreted as a timing gap between the UL transmission timing and the DL reception timing.
Since the DL transmission timing of the IAB node is adjusted by adjusting the DL transmission timing (TA/2+T_delta) of the IAB node a timing prior to the DL reception timing, it is necessary to set T_delta to (−1/2) of a time interval between the start of a UL transmission frame i of the IAB node and the start of a DL transmission frame i.
In a case in which Case #6 is supported, there are the following choices to enable the DL transmission adjustment (alignment) between the IAB nodes.
(Alt. 1): It may be necessary for the IAB node to execute the UL transmissions of Case #1 and Case #6 in parallel (consistently time multiplexed).
(Alt. 2): The time difference between the DL transmission timing and the UL reception timing in the parent node is signaled from the parent node to the IAB node in order to correct the potential mismatch of the DL transmission timing in the child node.

In this case, the child node compares the time difference between the DL transmission timing of the child node and the reception timing of the backhaul link, and in a case in which the transmission timing in the child node is delayed with the time difference signaled from the parent node which is larger than the value measured in the child node, the child node proceeds with the DL transmission timing.

### (3.2) Operation Examples

In the operation example to be described below, Over-the-Air (OTA) synchronization of Case #6 is implemented between the radio communication nodes that constitute the IAB.

### (3.2.1) Operation Condition

There are the following conditions regarding whether or not the IAB node can execute a single case or a plurality of cases related to the UL transmission timing adjustment of the MT described above.
(Condition 1): The IAB node can execute only the case of the UL transmission timing adjustment of any one of Case #1 and Case #6, and the case to be supported is set by the parent node in a semi-static manner.
(Condition 2): The IAB node can execute the UL transmission timing adjustments according to Case #1 and Case #6 in parallel and can dynamically indicate the case to be executed.

The following operation example relates to the UL transmission timing of the MT and the DL transmission timing of the DU in the IAB node in Case #6 under the condition 1 or the condition 2.

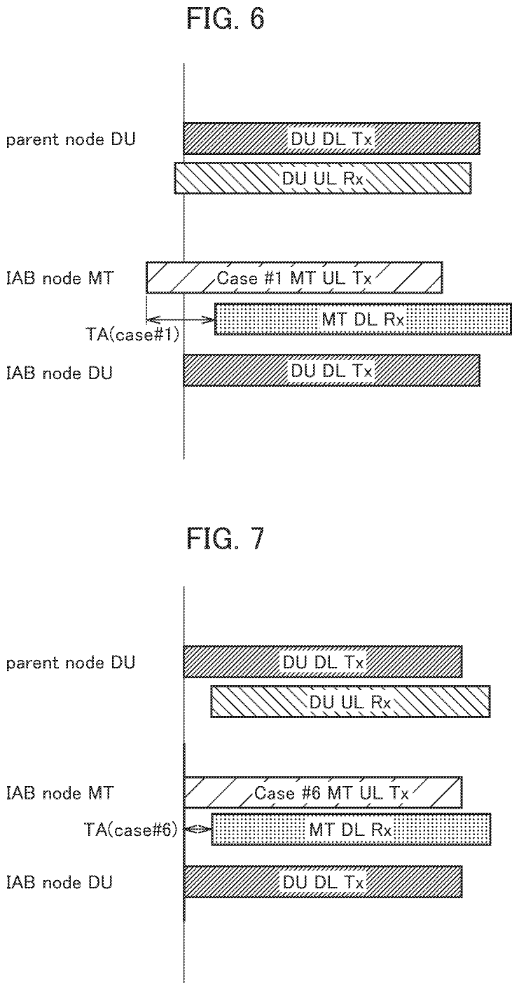

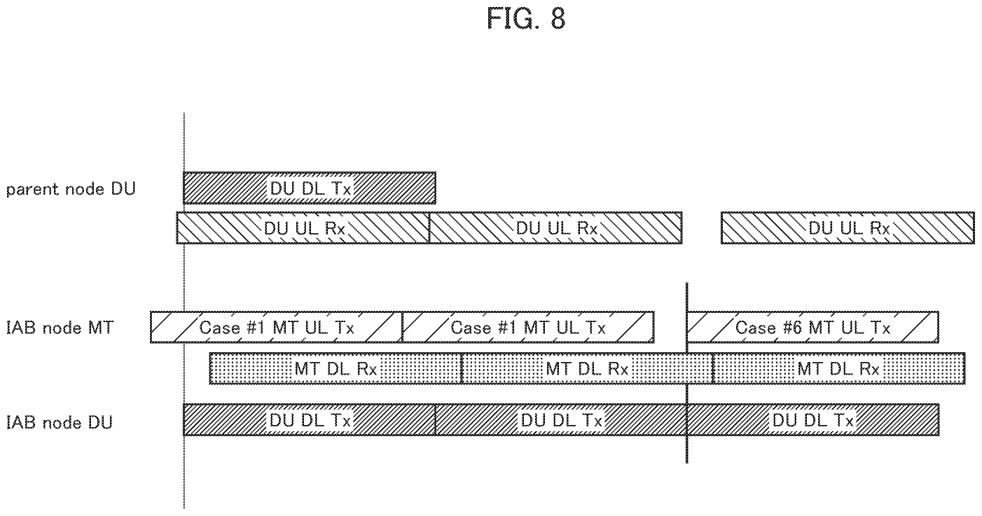

FIG. 6 illustrates an example of the transmission timing of the parent node and the IAB node when condition 1 is applied (Case #1). FIG. 7 illustrates an example of transmission timings of the parent node and the IAB node (Case #6) in a case in which the condition 1 is applied. FIG. 8 illustrates an example of transmission timings of the parent node and the IAB node in a case in which the condition 2 is applied.

As illustrated in FIGS. 6 and 7, in the case of the condition 1, the DL transmission timing of the parent node DU is aligned with the DL transmission timing of the IAB node DU, and the transmission timing of the parent node MT may differ depending on which of Case #1 and Case #6 is applied.

As illustrated in FIG. 8, in the case of the condition 2, the transmission timing adjustment according to Case #1 or the transmission timing adjustment according to Case #6 can be dynamically switched.

### (3.2.2) Operation Overview

In the case of the condition 1, the following operation examples are expected.
(Operation example 1a): The UL transmission timing of the MT uses the mechanism of Release 15. Specifically, the parent node calculates (TA/2+T_delta), and gives a notification indicating the result to the IAB node (which may be called the lower node or the child node, hereinafter the same) through the TA command (TAC). The TAC may be transmitted via the Random Access Response (RAR) or the MAC-CE.
(Operation example 1a-1): The UL transmission timing of the MT is on the basis of the TAC notified from the parent node (the mechanism of Release 16 is used in a case in which Case #1 is set).
(Operation example 1a-2): The DL transmission timing of the DU is aligned with the UL transmission timing of the MT.
(Operation example 1b): It follows the mechanism of Release 16
(Operation example 1b-1): The DL transmission timing of the DU is determined by calculating (TA/2+T_delta) by the IAB node.
(Operation example 1b-2): The UL transmission timing of the MT follows the mechanism of Release 16 (Case #1) or is aligned with the DL transmission timing of the DU (Case #6).

In the case of the condition 2, the following operation examples are expected.
(Operation example 2): The parent node transmits two types of TACs for Case #1 and Case #6.
(Operation example 2-1): The UL transmission timing of the MT is determined on the basis of the TAC of Case #6 (similar to the operation example 1a-1).
(Operation example 2-2): The DL transmission timing of the DU is aligned with the UL transmission timing of the MT (the operation example 1a-2) or follows the mechanism of Release 16 (similar to the operation example 1b-1).
(Operation example 3): The parent node gives a notification indicating the difference between the TAC of Case #1 and the TAC (that is, the propagation delay) of Case #6 and TAC to the IAB node.
(Operation example 3-1): The UL transmission timing of the MT is determined from Case #1 in consideration of the difference.
(Operation example 3-2): The DL transmission timing adjustment of the DU conforms to the operation example 2-2.
(Operation example 4): The parent node transmits the TAC of Case #1.
(Operation example 4-1): The DL transmission timing of the DU is determined by calculating (TA/2+T_delta) by the IAB node (similar to the operation example 1b-1)
(Operation example 4-2): The UL transmission timing of the MT follows the mechanism of Release 16 (Case #1) or is aligned with the DL transmission timing of the DU (Case #6) (similar to the operation example 1b-2).
(Operation example 5): The parent node gives a notification indicating which of Case #1 and Case #6 is set to the IAB node.
(Operation example 5-1): UL scheduling grant downlink control information (DCI) is used.
(Operation example 5-2): In a case in which the DU and the MT perform transmission at the same time, the IAB node determines that Case #6 is applied.
(Operation example 6): The IAB node gives a notification indicating capabilities related to a panel to the parent node.
(Operation example 6-1): The IAB node gives a notification new capability information (indicating single panel support or multiple-panel support) to the parent node.
(Operation example 6-2): The parent node gives a notification indicating whether or not Case #6 is supported to the IAB node using the RRC.

(3.2.3) Detailed Operation

The respective operation examples described above will be described below in detail.

### (3.2.3.1) The Operation Example 1a

In the present operation example, the UL transmission timing adjustment of the MT of the IAB node according to Case #6 is indicated by the parent node according to the mechanism of Release 15 via the TAC of the RAR or the MAC-CE. The DL transmission timing of the DU is aligned with the UL transmission timing of the MT according to Case #6.
(Operation example 1a-1): The UL transmission timing adjustment of the MT according to Case #6 follows the mechanism of Release 15. In other words, the UL transmission timing of the MT of the IAB node according to Case #6 is started before the start of the DL reception timing in the IAB node and is adjusted by the TAC of the RAR or the MAC CE.

However, unlike the legacy UL transmission timing adjustment, since the timing adjustment of Case #6 in the IAB node is supported, it is necessary for the parent node to indicate T_{TA} as the propagation delay between the parent node and the IAB node.
(Operation example 1a-2): In the case of the DL transmission timing of the DU, the IAB node causes the DL transmission timing of the DU to align with the UL transmission timing of the MT according to Case #6.

For example, the IAB node sets a start position of a DL transmission frame number i of the DU which is the same as a start position of a frame number i corresponding to the UL transmission of the MT according to Case #6.

Alternatively, the IAB node sets the start position (T_{TA}) of the DL transmission frame number i of the DU before the start of the frame number i corresponding to the DL reception timing of the MT. T_{TA} is a timing gap between the UL transmission timing and the DL reception timing according to Case #6.

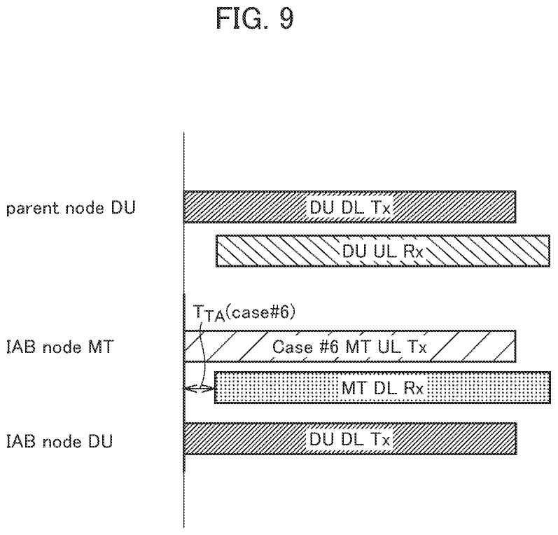

FIG. 9 illustrates an example of transmission timings of the parent node and the IAB node according to the operation example 1a. As illustrated in FIG. 9, T_{TA} is the timing gap between the UL transmission timing and the DL reception timing of the MT according to Case #6.

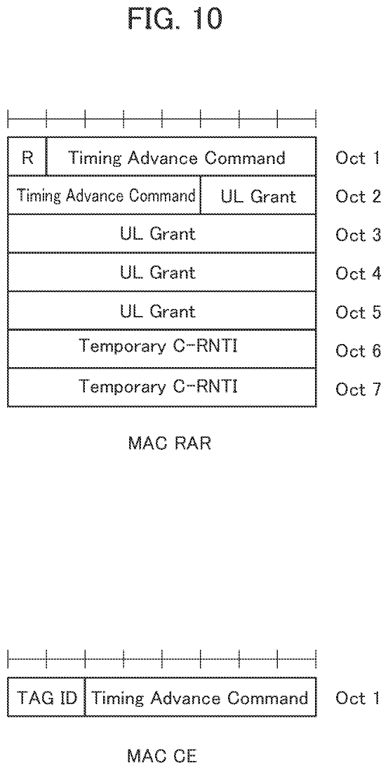

FIG. 10 illustrates configuration examples of the Random Access Response (RAR) and the MAC-CE. As illustrated in FIG. 10, in Release 15, the UL frame number for transmission from the user equipment (UE) starts before the start of the corresponding DL frame in the equipment.

A value (N_TA, offset) may be provided to the equipment by RRC signaling, or the equipment may determine a default value.

In the case of the initial access, TA is indicated via the TAC of the RAR (N_{TA}=T_{A}·16·64/2^{μ} T_{A}=0,1,2, . . . , 3846) In other cases, TA is indicated via the TAC of the MAC CE.

(N_{TA_new}=N_{TA_old}+(T_{A}−31)·16·64/2^{μ}T_{A}=0,1,2, . . . , 63)

### (3.2.3.2) Operation Example 1b

In the present operation example, the UL transmission timing of the MT according to Case #6 is aligned with the DL transmission timing of the DU. The DL transmission timing of the DU may follow the procedure of Release 16.
(Operation example 1b-1): The DL transmission timing adjustment of the DU follows the procedure of Release 16. In other words, it is necessary for the IAB node to set the DL transmission timing of the DU to (TA/2+T_delta) prior to the DL reception timing of the MT.

TA is the timing gap between the UL transmission timing and the DL reception timing according to Case #1.

It is necessary to set T_delta to (−1/2) of the time interval in the parent node from the start of the UL reception frame i of the IAB node according to Case #1 to the start of the DL transmission frame i.
(Operation example 1b-2): The MT UL transmission timing follows the mechanism of Release 16 (Case #1) or is aligned with the DL transmission timing of the DU (Case #6).

For example, the IAB node may set the start of the UL transmission of the MT according to Case #6 for the frame number i to be the same as the start of the frame number i corresponding to the DL transmission of the DU.

Alternatively, the IAB node may set the start of the UL transmission (TA/2+T_delta) of the MT according to Case #6 for the frame number i to a timing prior to the start of the frame number i corresponding to the DL reception of the MT.

TA is the timing gap between the UL transmission timing and the DL reception timing according to Case #1.

It is necessary to set T_delta to (−1/2) of the time interval in the parent node from the start of the UL reception frame i of the IAB node according to Case #1 to the start of the DL transmission frame i.

### (3.2.3.3) Operation Example 2

In the present operation example, a notification indicating the UL transmission timing adjustment of the MT according to Case #6 is directly given by the parent node that supports the mechanism of Release 15 via the TAC of the RAR or the MAC CE.
(Operation example 2-1): The UL transmission timing adjustment of the MT according to Case #6 is similar to that in the operation example 1a-1. A TAC MAC CE of the UL transmission timing according to Case #6 or Case #1 may be distinguished by using different logical channel IDs (LCIDs).
(Operation example 2-2): The DL transmission timing adjustment of the DU has the following choices.
(Operation example 2-2-1): Similarly to the operation example 1a-2, the DL transmission timing of the DU is aligned with the UL transmission timing according to Case #6.
(Operation example 2-2-2): The DL transmission timing adjustment of the DU follows the mechanism of Release 16. In other words, the IAB node sets the DL transmission timing of the DU to (TA/2+T_delta) prior to the DL reception timing of the MT.

TA is the timing gap between the UL transmission timing and the DL reception timing according to Case #1.

It is necessary to set T_delta to (−1/2) of the time interval in the parent node from the start of the UL reception frame i of the IAB node according to Case #1 to the start of the DL transmission frame i.

### (3.2.3.4) Operation Example 3

In the present operation example, the UL transmission timing of the MT according to Case #1 becomes the reference for the UL transmission timing adjustment of the MT according to Case #6. The UL transmission timing adjustment according to Case #1 follows the mechanism of Release 15. In the present operation example, the time interval between the UL transmission timing of the MT according to Case #1 and the UL transmission timing of the MT according to Case #6 is indicated by the parent node.
(Operation example 3-1): Regarding the UL transmission timing of the MT, the time interval (for example, T_offset) between the UL transmission timing of the MT according to Case #1 and the UL transmission timing of the MT according to Case #6 is indicated by the parent node. In other words, T_offset is a difference between the UL transmission timing of the MT according to Case #1 and the UL transmission timing of the MT according to Case #6.

The UL transmission timing according to Case #6 of the IAB node is T_offset after the UL transmission timing according to Case #1. It is necessary for the IAB node to set the UL transmission timing (TA-T_offset) of the MT according to Case #6 a timing prior to the DL reception timing.

TA is the timing gap between the UL transmission timing and the DL reception timing according to Case #1.

As described above, T_offset is indicated by the parent node via the RRC or the MAC CE. It is necessary to set T_offset to be set as the time interval between the UL reception timing according to Case #1 and the UL reception timing according to Case #6 in the parent node.

In a case in which the MAC CE is used to indicate T_offset, a reserved LCID can be used, or a format similar to the MAC CE for the TAC can be employed.

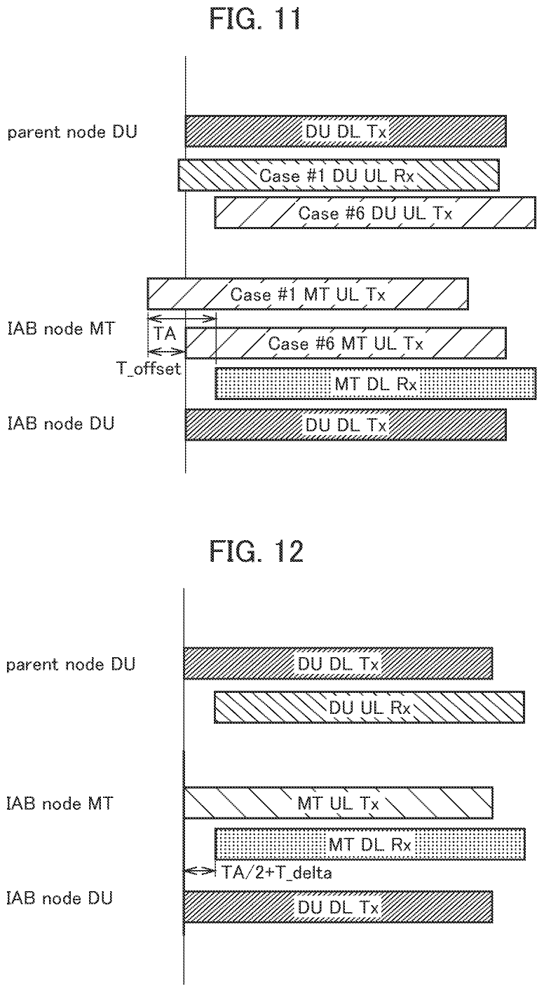

FIG. 11 illustrates an example of transmission timings of the parent node and the IAB node according to the operation example 3-1. As illustrated in FIG. 11, T_offset is the time interval between the UL transmission timing of the MT according to Case #1 and the UL transmission timing of the MT according to Case #6. TA is the timing gap between the UL transmission timing of the MT according to Case #1 and the DL reception timing of the MT.
(Operation example 3-2): The DL transmission timing adjustment of the DU is similar to that in the operation example 2-2.

### (3.2.3.5) Operation Example 4

In the present operation example, the UL transmission timing of the MT according to Case #6 is aligned with the DL transmission timing of the DU. The DL transmission timing of the DU may follow the procedure of Release 16.
(Operation example 4-1): The DL transmission timing adjustment of the DU follows the procedure of Release 16. In other words, it is necessary for the IAB node to set the DL transmission timing of the DU to (TA/2+T_delta) prior to the DL reception timing of the MT.

TA is the timing gap between the UL transmission timing and the DL reception timing according to Case #1.

It is necessary to set T_delta to (−1/2) of the time interval in the parent node from the start of the UL reception frame i of the IAB node according to Case #1 to the start of the DL transmission frame i.
(Operation example 4-2): In the case of the UL transmission timing of the MT, the IAB node causes the UL transmission timing of the MT according to Case #6 to align with the DL transmission timing of the DU.

For example, the IAB node may set the start of the UL transmission of the MT according to Case #6 for the frame number i to be the same as the start of the frame number i corresponding to the DL transmission of the DU.

Alternatively, the IAB node may set the start of the UL transmission (TA/2+T_delta) of the MT according to Case #6 for the frame number i to a timing prior to the start of the frame number i corresponding to the DL reception of the MT.

TA is the timing gap between the UL transmission timing and the DL reception timing according to Case #1.

It is necessary to set T_delta to (−1/2) of the time interval in the parent node from the start of the UL reception frame i of the IAB node according to Case #1 to the start of the DL transmission frame i.

FIG. 12 illustrates an example of transmission timings of the parent node and the IAB node according to the operation example 4-2. As illustrated in FIG. 12, there is a difference of TA/2+T_delta between the UL transmission of the MT of the IAB node and the DL reception of the MT. Specifically, the start of the UL transmission (TA/2+T_delta) of the MT is set to a timing prior to the start of the frame corresponding to the DL reception of the MT.

### (3.2.3.6) Operation Example 5

As described above, in the condition 2, the IAB node can execute the UL transmission timing adjustments according to Case #1 and Case #6 in parallel and can dynamically indicate the case to be executed. Such a dynamic case indication may be explicitly or implicitly given.
(Operation example 5-1): An indication indicating whether or not the UL transmission timing adjustment according to Case #1 or Case #6 is applied is explicitly given by the UL scheduling grant DCI.
(Operation example 5-2): Whether or not the UL transmission timing adjustment of Case #1 or Case #6 is applied is determined depending on whether or not the simultaneous transmission is executed using a specific radio resource.

Specifically, it is determined (supposed) that the UL transmission timing adjustment according to Case #6 is applied in a case in which the simultaneous transmission of the DU and the MT is executed, and otherwise, the UL transmission timing adjustment according to Case #1 is applied.

In the case of PRACH transmission, as a default IAB node operation, in a case in which the simultaneous transmission of the PRACH transmission of the MT and the DL transmission of the DU is supported, the PRACH reception timing of the MT may be defined to align with the DL transmission timing of the DU. Alternatively, a configuration in which the PRACH transmission follows the legacy (old) mechanism, and the simultaneous transmission is not supported is also possible.

In the case of the UL transmission other than the PRACH, determination of whether or not the simultaneous transmission is executed by using a specific radio resource can be performed depending on SDM and/or FDM support, UL scheduling permit of the MT, or the availability of the soft resource of the DU.

For example, in a case in which the UL transmission of the MT is scheduled and the radio resource can be used for the DL transmission of the DU, the UL transmission timing adjustment according to Case #6 may be executed.

### (3.2.3.7) Operation Example 6

In the present operation example, a notification (report) indicating information indicating the capability of the panel (which may be interpreted interchangeably with an antenna panel or a beam) of the IAB node is given from the IAB node to the parent node.
(Operation example 6-1): An information element (or field) indicating capability related to the panel of the IAB node, specifically, whether or not a single panel or a plurality of panels are disposed is defined.

The IAB node can report information related to functions of a single panel or a plurality of panels to the parent node. The information may be reported only when a single panel is disposed.

The parent node may request the IAB node to transmit the report. In the parent node, it is desirable that the IAB node recognize the need for the UL transmission timing adjustment according to Case #6. The UL transmission timing adjustment according to Case #6 is necessary in a case in which the IAB node executes SDM/FDM using a single panel, but it is not necessary in a case in which a plurality of panels is used.
(Operation example 6-2): The parent node gives a notification indicating whether or not Case #6 is supported to the IAB node using the RRC.

In this case, the default operation of the IAB node may be defined as shown in Table 1.

TABLE 1

| | | Not support |
|---|---|---|
| | Support SDM/FDM | SDM/FDM |
| Single panel | Alt. 1 Case #1 | Case #1 |
| | Alt. 2 Case #6 | |
| | Alt. 3 Time multiplexed | |
| | Case #1 and case #6 | |
| Multiple panel | Case #1 | Case #1 |

As illustrated in Table 1, in a case in which the IAB node includes a single panel and SDM/FDM is supported, the default operation of the IAB node may be assumed to be time division multiplexing (dynamic switching) of any one of Case #1, Case #6, or Case #1 and Case #6.

On the other hand, in a case in which the IAB node includes a plurality of panels and SDM/FDM is supported or in a case in which SDM/FDM is not supported, the default operation of the IAB node may be assumed to be Case #1.

### (4) Operational Effects

According to the above embodiment, the following operational effects can be obtained. Specifically, the radio communication node 100A (the parent node) transmits the timing information including T_{propagation_0} to the radio communication node 100B (the IAB node).

Further, the radio communication node 100A can transmit the propagation delay (the first propagation delay) between the parent node and the IAB node (the lower node) used for determining the DL transmission timing, that is, TA according to Case #1 and the propagation delay (the second propagation delay) used for determining the UL transmission timing in the IAB node, that is, the timing information including TA according to Case #6 to the radio communication node 100B. Alternatively, the radio communication node 100A can transmits the difference (T_offset) of TA.

Therefore, even in a case in which Case #6 is supported, in addition to Case #1, the UL transmission timing of the MT can be aligned with the DL transmission timing of the IAB node and the child node DU. In other words, according to the radio communication system 10, in IAB, the transmission timings of the DU and the MT can be reliably aligned with each other.

In the present embodiment, the radio communication node 100B (the IAB node) can cause the UL transmission timing of the MT to align with the DL transmission timing of the DU in a case in which the UL transmission timing according to Case #6 is adjusted.

Further, in the present embodiment, in a case in which the UL transmission timing adjustment according to Case #6 is determined to be adjusted, the radio communication node 100A (the parent node) can transmit the information indicating that the transmission timing adjustment is to be performed to the IAB node (the lower node).

Therefore, even in a case in which Case #6 is supported, in addition to Case #1, the UL transmission timing of the MT can be aligned with the DL transmission timing of the IAB node and the child node DU.

In the present embodiment, in a case in which a single panel is disposed (a plurality of panels are disposed, but a case in which a single panel is used is also included), the radio communication node 100B (the IAB node) can transmit the information (for including the capability) indicating that a single panel is used to the parent node (the higher node).

Therefore, the parent node can reliably determine whether or not the UL transmission timing adjustment according to Case #6 is necessary. Accordingly, in IAB, the transmission timings of the DU and the MT can be reliably aligned with each other.

### (5) Other Embodiments

Although the content of the present invention has been described above with reference to the embodiment, it is obvious to those skilled in the art that the present invention is not limited to the above description, and various modifications and improvements can be made.

For example, in the above-described embodiment, the names such as the parent node, the IAB node, and the child node are used, but different names may be used as long as the radio communication node in which the radio backhaul between the radio communication nodes such as gNBs and the radio access with the user equipment are integrated is employed. For example, they may be simply called first and second nodes or may be called higher nodes, lower nodes, relay nodes, intermediate nodes, or the like.

Also, the radio communication node may be simply called a communication device or communication node or may be interpreted interchangeably with a radio base station.

In the above embodiment, the terms downlink (DL) and uplink (UL) are used, but they may be called by other terms. For example, it may be replaced with or associated with terms such as forward link, reverse link, access link, or backhaul. Alternatively, terms such as 1st link, 2nd link, 1st direction, 2nd direction, or the like may simply be used.

Further, the block configuration diagrams (FIGS. 3 and 4) used to describe the embodiment described above indicate blocks of function units. Those functional blocks (structural components) can be realized by a desired combination of at least one of hardware and software. A realization method of each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

The functions include determining, deciding, judging, computing, calculating, processing, deriving, investigating, searching, confirming, receiving, transmitting, outputting, accessing, resolving, selecting, choosing, establishing, comparing, assuming, expectation, regarding, broadcasting, notifying, communicating, forwarding, configuring, reconfiguring, allocating, mapping, assigning, and the like but are not limited thereto. For example, a functional block (structural component) that causes transmitting may be called a transmitting unit or a transmitter. For any of the above, as explained above, the realization method is not particularly limited to any one method.

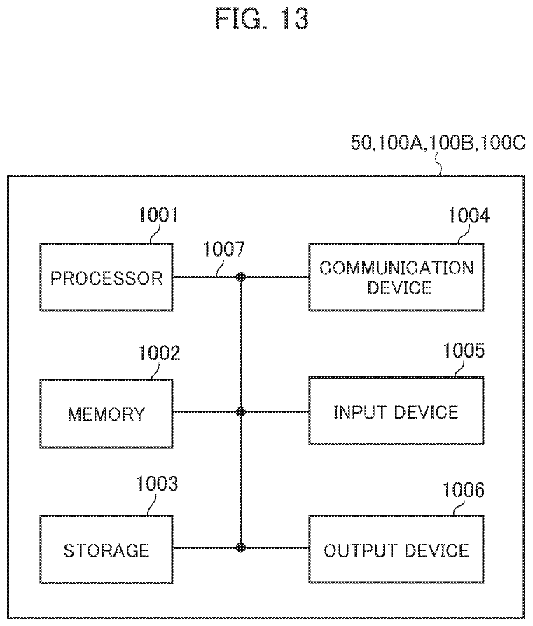

Further, the CU 50 and the radio communication nodes 100A to 100C (the devices) described above may function as a computer that performs processing of the radio communication method of the present disclosure. FIG. 13 is a diagram illustrating an example of a hardware configuration of the device. As illustrated in FIG. 13, the device may be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. Hardware configuration of the device can be constituted by including one or plurality of the devices illustrated in the figure, or can be constituted by without including a part of the devices.

Each functional block of the device (see FIGS. 3 and 4) is realized by any hardware element of the computer device or a combination of the hardware elements.

Moreover, the processor 1001 performs computing by loading a predetermined software (computer program) on hardware such as the processor 1001 and the memory 1002, and realizes various functions of the device by controlling communication via the communication device 1004, and controlling reading and/or writing of data on the memory 1002 and the storage 1003.

The processor 1001, for example, operates an operating system to control the entire computer. The processor 1001 can be configured with a central processing unit (CPU) including an interface with a peripheral device, a control device, a computing device, a register, and the like.

Moreover, the processor 1001 reads a computer program (computer program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (UM), and the like. The memory 1002 can be called register, cache, main memory (main memory), and the like. The memory 1002 can store therein a computer program (computer program codes), software modules, and the like that can execute the method according to the embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

In addition, the respective devices, such as the processor 1001 and the memory 1002, are connected to each other with the bus 1007 for communicating information thereamong. The bus 1007 may be configured by using a single bus or may be configured by using a different bus between devices.

Further, the device may be configured to include hardware such as a microprocessor, a digital signal processor (DSP), an application specific integrated circuit (ASIC), a programmable logic device (PLD), or a field programmable gate array (FPGA) or all or some of the functional blocks may be implemented by hardware. For example, the processor 1001 may be implemented by using at least one of these hardware.

Notification of information is not limited to that explained in the above aspect/embodiment, and may be performed by using a different method. For example, the notification of information may be performed by physical layer signaling (for example, Downlink Control Information (DCI), Uplink Control Information (UCI), upper layer signaling (for example, RRC signaling, Medium Access Control (MAC) signaling, notification information (Master Information Block (MIB), System Information Block (SIB)), other signals, or a combination of these. The RRC signaling may be called RRC message, for example, or can be RRC Connection Setup message, RRC Connection Reconfiguration message, or the like.

Each aspect and embodiment of the present invention may be applied to at least one of Long Term Evolution (LTE), LTE-advanced (LTE-A), SUPER 3G, IMT-advanced, 4th generation mobile communication system (4G), 5^{th} generation mobile communication system (5G), Future Radio Access (FRA), New Radio (NR), W-CDMA (registered trademark), GSM (registered trademark), CDMA 2000, Ultra Mobile Broadband (M4B), IEEE 802.11 (Wi-Fi (registered trademark)), IEEE 802.16 (WiMAX (registered trademark)), IEEE 802.20, Ultra-WideBand (UWB), Bluetooth (registered trademark), a system using any other appropriate system, a next generation systems extended on the basis of these standards, or the like. Further, a plurality of systems may be combined (for example, a combination of at least one of the LTE and the LTE-A with the 5G).

As long as there is no inconsistency, the order of processing procedures, sequences, flowcharts, and the like of each of the above aspects/embodiments in the present disclosure may be exchanged. For example, the various steps and the sequence of the steps of the methods explained above are exemplary and are not limited to the specific order mentioned above.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example 1n which there is one network node other than the base station is explained; however, a combination of a plurality of other network nodes (for example, MME and S-GW) may be used.

Information and signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each aspect/embodiment described in the present disclosure may be used separately or in combination, or may be switched in accordance with the execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, computer program code, computer program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of a channel and a symbol may be a signal (signaling). Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The moving body may be a vehicle (for example, a car, an airplane, or the like), a moving body that moves unmanned (for example, a drone, an automatically driven vehicle, or the like), a robot (manned type or unmanned type). At least one of a base station and a mobile station can be a device that does not necessarily move during the communication operation. For example, at least one of a base station and a mobile station may be an Internet of Things (IoT) device such as a sensor.

Also, a base station in the present disclosure may be read as a mobile station (user terminal, hereinafter the same). For example, each of the aspects/embodiments of the present disclosure may be applied to a configuration that allows a communication between a base station and a mobile station to be replaced with a communication between a plurality of mobile stations (for example, may be referred to as Device-to-Device (D2D), Vehicle-to-Everything (V2X), or the like). In this case, the mobile station may have the function of the base station. Words such as “uplink” and “downlink” may also be replaced with wording corresponding to inter-terminal communication (for example, “side”). For example, terms an uplink channel, a downlink channel, or the like may be read as a side channel.

Likewise, a mobile station in the present disclosure may be read as a base station. In this case, the base station may have the function of the mobile station.

A radio frame may include one or more frames in the time domain. In the time domain, each of one or more frames may be called a sub frame.

The sub frame may further include one or more slots in the time domain. The sub frame may have a fixed time length (for example, 1 ms) not depending on numerology.

The numerology may be a communication parameter applied to at least one of transmission and reception of a certain signal or channel. For example, the numerology may indicate at least one of a subcarrier spacing (SCS), a bandwidth, a symbol length, a cyclic prefix length, a transmission time interval (TTI), a number of symbols per TTI, a radio frame configuration, a specific filtering processing performed in the frequency region by a transceiver, a specific windowing processing performed in the time domain by a transceiver, and the like.

The slot may include one or more symbols (orthogonal frequency division multiplexing (OFDM) symbols, single carrier frequency division multiple access (SC-FDMA) symbols, or the like) in the time domain. The slot may be a time unit based on the numerology.

The slot may include a plurality of mini slots. Each mini slot may include one or more symbols in the time domain. Further, the mini slot may be called a sub slot. The mini slot may include fewer symbols than a slot. A PDSCH (or PUSCH) transmitted in units of times greater than the mini slot may be called a PDSCH (or PUSCH) mapping type A. A PDSCH (or PUSCH) transmitted using a mini slot may be called a PDSCH (or PUSCH) mapping type B.

All of a radio frame, a sub frame, a slot, a mini slot, and a symbol indicates a time unit for transmitting a signal. As a radio frame, a sub frame, a slot, a mini slot, and a symbol, different designations respectively corresponding to them may be used.

For example, one sub frame may be called a transmission time interval (TTI: Transmission Time Interval), or a plurality of consecutive sub frames may be called TTIs, or one slot or one mini slot may be called a TTI. In other words, at least one of the sub frame and the TTI may be a sub frame (1 ms) in the existing LTE, may be a period shorter than 1 ms (for example, 1 to 13 symbols), or may be referred to as a period longer than 1 ms. A unit representing the TTI may be called slot, a mini slot, or the like instead of the sub frame.

Here, for example, the TTI refers to a minimum time unit of scheduling in radio communication. For example, in the LTE system, the base station performs scheduling of allocating a radio resource (a frequency band width, a transmission power, or the like which can be used in each user equipment) to each user equipment in units of TTIs. The definition of the TTI is not limited thereto.

The TTI may be a transmission time unit such as a channel coded data packet (transport block), a code block, or a codeword, or may be a processing unit such as scheduling or link adaptation. Further, when a TTI is given, a time interval (for example, the number of symbols) in which a transport block, a code block, a codeword, or the like is actually mapped may be shorter than the TTI.

Further, when one slot or one mini slot is called a TTI, one or more TTIs (that is, one or more slots or one or more mini slots) may be a minimum time unit of scheduling. Further, the number of slots (the number of mini slots) constituting the minimum time unit of scheduling may be controlled.

A TTI having a time length of 1 ms may be called a common TTI (TTI in LTE Rel. 8 to 12), a normal TTI, a long TTI, a common sub frame, a normal sub frame, a long sub frame, a slot, or the like. A TTI shorter than the common TTI may be called a reduced TTI, a short TTI, a partial TTI (a partial or fractional TTI), a reduced sub frame, a short sub frame, a mini slot, a sub slot, a slot, or the like.

Further, a long TTI (for example, a common TTI, a sub frame, or the like) may be replaced with a TTI having a time length exceeding 1 ms, and a short TTI (for example, a reduced TTI or the like) may be replaced with a TTI having a TTI length which is less than a TTI length of a long TTI and equal to or more than 1 ms.

The resource block (RB) is a resource allocation unit in the time domain and the frequency region and may include one or more consecutive subcarriers in the frequency region. The number of subcarriers included in an RB may be the same irrespective of a numerology and may be, for example, 12. The number of subcarriers included in an RB may be decided on the basis of a numerology.

Further, a time domain of an RB may include one or more symbols and may be a length of one slot, one mini slot, one sub frame, or one TTI. Each of one TTI, one sub frame, or the like may be constituted by one or more resource blocks.

Further, one or more RBs may be called a physical resource block (PRB), a subcarrier group (SCG), a resource element group (REG), a PRB pair, or the like.

Further, the resource block may be constituted by one or more resource elements (RE). For example, one RE may be a radio resource region of one subcarrier and one symbol.

A bandwidth part (BWP) (which may be called a partial bandwidth) may indicate a subset of consecutive common resource blocks (RBs) for a certain numerology in a certain carrier. Here, a common RB may be specified by an index of an RB based on a common reference point of a carrier. A PRB may be defined in a BWP and numbered in a BWP.

The BWP may include a BWP for UL (UL BWP) and a BWP for DL (DL BWP). In a UE, one or more BWPs may be configured within one carrier.

At least one of configured BWPs may be active, and it may not be assumed that the UE transmits and receives a predetermined signal/channel outside an active BWP. Further, a “cell,” a “carrier,” or the like in the present disclosure may be replaced with a “BWP.”

Structures of the radio frame, the sub frame, slot, the mini slot, and the symbol are merely examples. For example, configurations such as the number of sub frames included in a radio frame, the number of slots per sub frame or radio frame, the number of mini slots included in a slot, the number of symbols and RBs included in a slot or a mini slot, the number of subcarriers included in an RB, the number of symbols in a TTI, a symbol length, a cyclic prefix (CP) length, and the like can be variously changed.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using one or more wires, cables, printed electrical connections, and as some non-limiting and non-exhaustive examples, by using electromagnetic energy having wavelengths in the radio frequency region, the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

Further, “means” in the configuration of each of the above devices may be replaced with “unit,” “circuit,” “device,” or the like.

Any reference to an element using a designation such as “first”, “second”, and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as “a”, “an”, and “the” in English are added, in this disclosure, these articles shall include plurality of nouns following these articles.

The terms “determining” and “deciding” used in this specification may include a wide variety of operations. For example, “determining” and “deciding” may include, for example, events in which events such as judging, calculating, computing, processing, deriving, investigating, looking up, search, and inquiry (for example, looking up in a table, a database, or another data structure), or ascertaining are regarded as “determining” or “deciding.” Further, “determining” and “deciding” may include, for example, events in which events such as receiving (for example, receiving information), transmitting (for example, transmitting information), input, output, or accessing (for example, accessing data in a memory) are regarded as “determining” or “deciding.” Further, “determining” and “deciding” may include, for example, events in which events such as resolving, selecting, choosing, establishing, or comparing are regarded as “determining” or “deciding.” In other words, “determining” and “deciding” may include events in which a certain operation is regarded as “determining” or “deciding.” Further, “determining (deciding)” may be replaced with “assuming,” “expecting,” “considering,” or the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 RADIO COMMUNICATION SYSTEM
50 CU
100A, 100B, 100C RADIO COMMUNICATION NODE
110 RADIO TRANSMITTING UNIT
120 RADIO RECEIVING UNIT
130 NW IF UNIT
140 IAB NODE CONNECTING UNIT
150 CONTROL UNIT
161 RADIO TRANSMITTING UNIT
162 RADIO RECEIVING UNIT
170 HIGHER NODE CONNECTING UNIT
180 LOWER NODE CONNECTING UNIT
190 CONTROL UNIT
UE 200
1001 PROCESSOR
1002 MEMORY
1003 STORAGE
1004 COMMUNICATION DEVICE
1005 INPUT DEVICE
1006 OUTPUT DEVICE
1007 BUS

1. A radio communication node comprising:
a control unit that acquires, in a case in which a downlink transmission timing and an uplink transmission timing in a lower node are adjusted, a propagation delay between the radio communication node and the lower node; and
a transmitting unit that transmits timing information including the propagation delay to the lower node.

2. A radio communication node comprising:
a control unit that causes, in a case in which a downlink transmission timing and an uplink transmission timing in the radio communication node are adjusted, the uplink transmission timing to align with the downlink transmission timing; and
a transmitting unit that transmits an uplink on the basis of the transmission timing.

3. A radio communication node comprising:
a control unit that acquires, in a case in which a downlink transmission timing and an uplink transmission timing in a lower node are adjusted, a first propagation delay between the radio communication node and the lower node used for determining the downlink transmission timing and a second propagation delay between the radio communication node and the lower node used for determining the uplink transmission timing; and
a transmitting unit that transmits timing information including the first propagation delay and the second propagation delay to the lower node.

4. A radio communication node comprising:
a control unit that acquires, in a case in which a downlink transmission timing and an uplink transmission timing in a lower node are adjusted, a first propagation delay between the radio communication node and the lower node used for determining the downlink transmission timing and a second propagation delay between the radio communication node and the lower node used for determining the uplink transmission timing; and
a transmitting unit that transmits timing information including a difference between the first propagation delay and the second propagation delay to the lower node.

5. A radio communication node comprising:
a control unit that determines whether or not to adjust a downlink transmission timing and an uplink transmission timing in a lower node; and
a transmitting unit that transmits, in a case in which the downlink transmission timing and the uplink transmission timing in the lower node are determined to be adjusted, information indicating that the downlink transmission timing and the uplink transmission timing in the lower node are adjusted to the lower node.

6. A radio communication node comprising:
a radio unit that transmits and receives radio signals using a single panel; and
a transmitting unit that transmits information indicating that the panel is used to a higher node.
